(19) United States
(12) Patent Application Publication
(10) Pub. No.: US 2026/0120348 A1
(43) Pub. Date: Apr. 30, 2026

(54) Crack Image Generation Method, Machine Learning Method of Crack Determination AI, and Crack Inspection Method

(71) Applicant: Hitachi GE Vernova Nuclear Energy, Ltd., Hitachi-shi (JP)

(72) Inventors: Takeshi SHIMANO, Tokyo (JP); Naoki HOSOYA, Tokyo (JP)

(21) Appl. No.: 19/318,728

(22) Filed: Sep. 4, 2025

(30) Foreign Application Priority Data
Oct. 31, 2024 (JP) 2024-191701

(51) Int. Cl. G06T 11/00; G06T 7/00; G06T 7/73; G06T 7/90

(52) U.S. Cl. CPC G06T 11/10; G06T 7/0008; G06T 7/73; G06T 7/90; G06T 2207/10024; G06T 2207/20081; G06T 2207/30108

(57) ABSTRACT

A crack image generation method according to an aspect of the present invention is a crack image generation method of generating a crack image (107) by a calculator (500) including a computation device (501) configured to execute a program and a storage device (502) configured to store the program. The crack image generation method includes: processing of generating, by the computation device (501), a pseudo crack image (106) by randomly determining a value of at least one element among elements defining a shape of a pseudo crack using a random number; and processing of generating, by the computation device (501), the crack image (107) by superimposing the pseudo crack image (106) on an image (103) of a real subject.

### BACKGROUND

### Technical Field

The present invention relates to a crack image generation method, a machine learning method of a crack determination artificial intelligence (AI), and a crack inspection method using the crack determination AI.

### Related Art

In appearance inspection of an inspection target object, a defect image including an appearance defect is compared with a normal appearance image to determine the presence or absence of a defect. Recently, it has been attempted to apply machine learning to defect inspection. From the viewpoint of improving inspection accuracy, it is desirable that the number of defect images used for machine learning is large.

Patent Literature 1 discloses a technology for reducing time and effort to collect an image of a defective portion for learning in appearance inspection using machine learning. Patent Literature 1 describes a method of generating a pseudo defect image by placing a defective portion image of a defect library storing the defective portion image in an inspection region in a normal product image. According to the technology described in Patent Literature 1, when generating pseudo defect images of a plurality of processed products having different specifications, various pseudo defect images can be easily generated by using a common defective portion image.

### CITATION LIST

### Patent Literature

Patent Literature 1: JP 2023-180697 A

### SUMMARY

In the technology described in Patent Literature 1, it is possible to easily generate various pseudo defect images for a plurality of processed products. However, it has been difficult to use the technology for crack inspection. When applying the technology described in Patent Literature 1 to remote visual inspection for a nuclear reactor or the like, there is a practical issue in that the number of actual crack images is small due to a low frequency of crack occurrence, and thus, a crack library storing crack images cannot be constructed.

The shape of a crack is more complex than the shape of a defect of a processed product, and it is not easy to pattern such shapes. Even if the crack library can be constructed, an imaging magnification of a normal image as a background image and a magnification of the crack image of the crack library do not necessarily match, and there may be a mismatch in luminance, color tone, or resolution. As a result, there is a possibility that an unrealistic or unnatural crack image is obtained.

In view of the above situation, there has been a demand for a method capable of randomly generating a large number of realistic and authentic-looking crack images for use in machine learning.

In order to solve the above problem, a crack image generation method according to an aspect of the present invention is a crack image generation method of generating a crack image by a calculator including a computation device configured to execute a program and a storage device configured to store the program. The crack image generation method includes: processing of generating, by the computation device, a pseudo crack image by randomly determining a value of at least one element among elements defining a shape of a pseudo crack using a random number; and processing of generating, by the computation device, a crack image by superimposing the pseudo crack image on an image of a real subject.

According to at least one aspect of the present invention, it is possible to generate a large number of realistic and authentic-looking crack images in a short time. Therefore, machine learning of a crack determination artificial intelligence (AI) can be efficiently and easily performed by using a large number of such crack images.

Problems, configurations, and effects other than those described above will be clarified by the following description of embodiments for carrying out the invention.

### BRIEF DESCRIPTION OF DRAWINGS

FIG. 1 is a diagram illustrating a concept (training phase) of generating a crack image for machine learning using a captured image obtained by imaging an inside of a nuclear reactor containment vessel using an inspection camera in a crack inspection system according to one embodiment of the present invention;

FIG. 2 is a diagram illustrating a concept (inference phase) of displaying a determination assistance output by using a trained crack determination artificial intelligence (AI) for remote visual inspection in the crack inspection system according to one embodiment of the present invention;

FIG. 3 is a block diagram illustrating an example of an internal configuration of the crack determination AI used in the crack inspection system according to one embodiment of the present invention;

FIG. 4 is a diagram illustrating an example of processing in an edge cutting unit of the crack determination AI;

FIG. 5 is a block diagram illustrating a hardware configuration example of a calculator used in the crack inspection system according to one embodiment of the present invention;

FIG. 6 is a diagram illustrating a flow of processing of generating a pseudo crack image based on a crack shape condition and a variation condition;

FIG. 7 is a diagram for describing the basis of a formula for a normally distributed random number;

FIG. 8 is a diagram for describing a method of determining a luminance when the pseudo crack image having an assumed crack shape is superimposed on a captured image without a crack; and

FIG. 9 is a diagram illustrating an optical model for image formation calculation.

### DETAILED DESCRIPTION

Hereinafter, examples of modes for carrying out the present invention (hereinafter, referred to as “embodiments”) will be described with reference to the accompanying drawings.

In the present specification and the accompanying drawings, the same reference signs are given to common components or similar components, and redundant description is omitted. In addition, in a case where there are a plurality of the same or similar components, the same reference signs may be attached with different subscripts for description. In a case where it is not necessary to distinguish the plurality of components, the subscripts may be omitted. The number of components may be singular or plural unless otherwise specified.

First, a remote inspection system according to one embodiment of the present invention will be described.

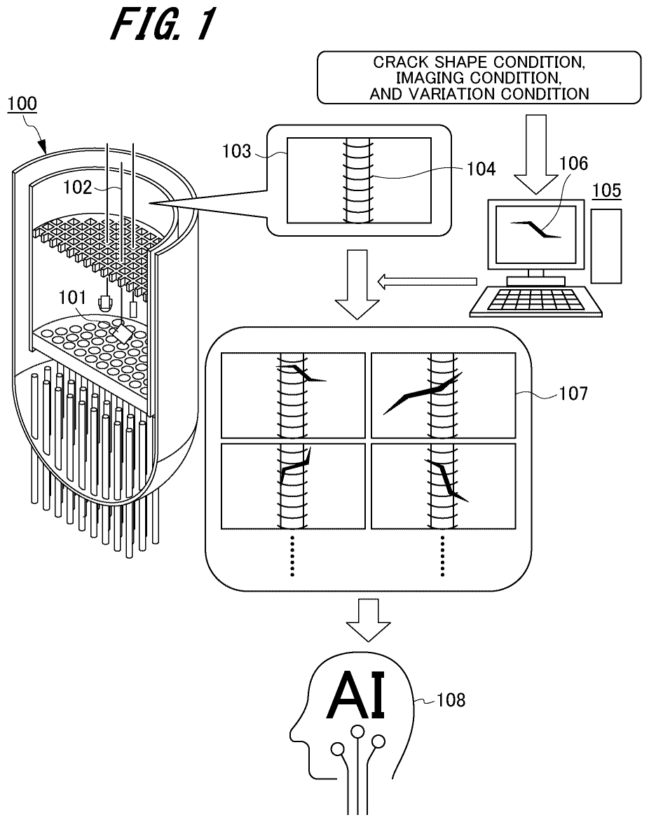

FIG. 1 is a diagram illustrating a concept of generating a crack image for machine learning using an image obtained by imaging the inside of a nuclear reactor containment vessel using an inspection camera.

In a nuclear reactor of a nuclear power plant, an inspection camera 101 is suspended by a cable 102 and a posture control rope (not illustrated) in a nuclear reactor containment vessel 100. At the time of periodic inspection or special inspection of the nuclear reactor, the inside of the nuclear reactor containment vessel 100 is imaged by the inspection camera 101 suspended in the nuclear reactor containment vessel 100, and whether or not a crack has occurred on an inner wall surface is visually inspected remotely.

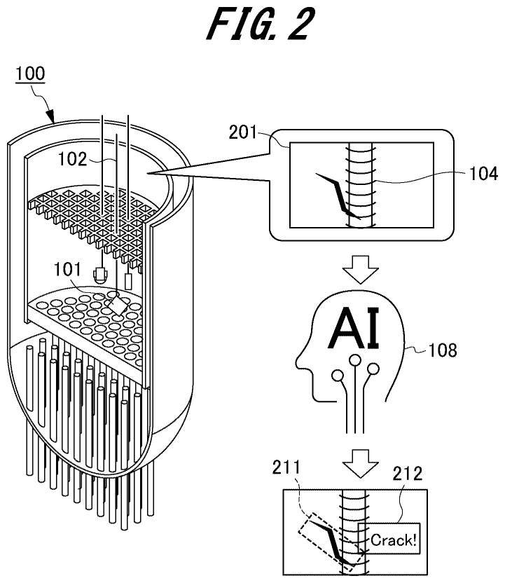

An inspector monitors an inspection image 201 (see FIG. 2) output from the inspection camera 101 on a monitor, and crack determination assistance by a crack determination artificial intelligence (AI) 108 is expected in order to reduce a burden on the inspector. In order to enable the crack determination AI 108 to determine the crack from the inspection image 201, it is necessary to cause the crack determination AI 108 to learn a large number of images including cracks in advance. However, there is a problem that there are few crack images that can be learned due to a low frequency of crack occurrence.

Therefore, in one embodiment of the present invention, a large number of different pseudo crack images 106 are generated by a pseudo crack image generation computer 105 using an assumed crack shape condition, an imaging condition, a variation condition, and the like as inputs. A crack shape is changed by changing a value of each element defining the crack shape. Next, a large number of different crack images 107 are generated by superimposing each of the large number of pseudo crack images 106 on an actual captured image 103 without a crack. Then, the crack determination AI 108 performs machine learning using the large number of crack images 107. That is, the pseudo crack image 106 is combined with the captured image 103 to create the crack image 107 to be used for machine learning.

At this time, the crack image 107 (including the pseudo crack image 106) to be learned needs to be an image as similar as possible to an image that may actually occur (the inspection image 201 in FIG. 2). Therefore, it is desirable that the crack image 107 to be learned is an image of which a size, a brightness, a contrast, a resolution, and the like are assumed as accurately as possible according to a size and a luminance of a structure such as a weld bead 104 appearing in the inspection image.

For example, a magnification of an optical system is determined depending on the number of pixels corresponding to a size of the crack in the image with respect to the actual size of the structure. Then, an opening width of the crack to be superimposed on a screen is determined depending on the magnification of the optical system. Since the opening width of the crack assumed in remote visual inspection is about several μm to 20 μm, the opening width of the crack in the image when the crack is imaged by the inspection camera 101 is generally smaller than one pixel.

However, the fact that the opening width of the crack is smaller than one pixel does not mean that the crack cannot be recognized. The luminance of one pixel is reduced according to an area ratio between the pixel and the crack in the pixel. By continuously performing such processing in an extension direction (occurrence direction) of the crack, the inspector can recognize the crack. Whether or not the crack is recognizable is determined depending on a relationship between the opening width of the crack and the size of the structure. Therefore, when creating the pseudo crack image, it is important to accurately grasp a size of the pseudo crack image.

Similarly, a contrast of a relative luminance of the pseudo crack image with respect to a luminance of the structure without a crack also closely affects whether or not the pseudo crack image can be recognized as the crack. The crack is generally assumed to have a depth larger than the opening width. Therefore, it is considered that light entering the crack attenuates by being repeatedly reflected on the inner wall surface, and a luminance of an image of a crack portion can be assumed to be a luminance of a dark portion of an image sensor. Therefore, it is considered that the crack is hardly recognized in a dark region where the luminance of the structure is low. In addition, an interface of the nuclear reactor containment vessel exposed by the crack generally has a high reactivity of atoms and molecules, and sometimes adsorbs surrounding dust or is oxidized to form so-called rust. In such a case, there may be a case where the crack portion is instead raised by dust or rust and appears white due to light scattering. Under an environment where such a case is assumed, it is necessary to train the crack determination AI 108 by assuming a white crack.

By the way, even if the crack is a crack that the inspector is able to recognize with the size and the contrast of the luminance, the inspection camera 101 may not be in focus and the resolution may decrease. On the other hand, even when the inspection camera 101 is in focus, diffraction blur may occur due to a small apparent size of the distant crack. It is necessary to train the crack determination AI 108 by accurately considering such defocus and distance conditions that deteriorate the resolution. That is, it is necessary to select the captured image on which the pseudo crack image is to be superimposed so as to obtain the crack image 107 meaningful for training.

In addition, it is difficult to determine how realistic and authentic-looking crack images need to be for machine learning of the crack determination AI 108. However, it is considered desirable that the pseudo crack image is likely to be determined as a crack by the inspector when the inspector finally observes the image. As a result of collecting and observing a large number of images of general cracks disclosed on the Internet by the present inventors, it has been found that many cracks extend while having a generally consistent directional tendency while exhibiting a randomly zigzagging shape. Furthermore, it has been found that random shear displacement occurs even within one segment of the crack bent in the zigzagging shape.

In consideration of the above relationship, as the crack shape conditions, a length, the opening width, a bending amplitude of the crack, an inclination, and the like are given to the pseudo crack image generation computer 105. Furthermore, as the imaging conditions, a distance, a camera resolution, an illumination condition, and the like are given to the pseudo crack image generation computer 105. Furthermore, as the variation conditions, a standard deviation of each setting parameter, a random number value for introducing variation, and the like are given to the pseudo crack image generation computer 105. Then, the pseudo crack image 106 reflecting such conditions is calculated by the pseudo crack image generation computer 105 and superimposed on the captured image 103. The superimposition processing may be performed by the pseudo crack image generation computer 105 or may be performed by another computer (not illustrated). In the following description, a pseudo crack may be simply referred to as “crack”.

FIG. 2 is a diagram illustrating a concept of displaying a determination assistance output (alert indicator) by using the crack determination AI 108 trained in this manner for remote visual inspection.

The trained crack determination AI 108 performs processing of determining the presence or absence of a crack on the inspection image 201 output by the inspection camera 101. Here, in a case where there is a pattern assumed to be a crack in the inspection image 201, the trained crack determination AI 108 indicates a corresponding portion in the inspection image 201 with a contour line 211 such as a quadrangle, a determination assistance output 212, and the like. As a result, it is possible to alert the inspector that there is a portion suspected as a crack in the inspection image 201.

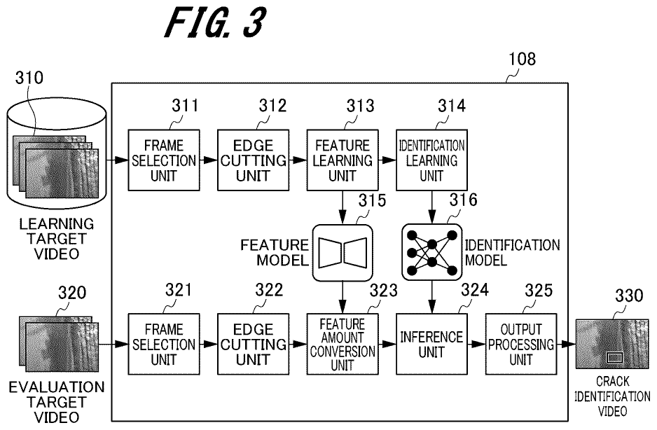

FIG. 3 is a block diagram illustrating an example of an internal configuration of the crack determination AI 108 used in a crack inspection system according to one embodiment of the present invention.

As illustrated in FIG. 3, the crack determination AI 108 includes a frame selection unit 311, an edge cutting unit 312, a feature learning unit 313, an identification learning unit 314, a feature model 315, and an identification model 316. Furthermore, the crack determination AI 108 includes a frame selection unit 321, an edge cutting unit 322, a feature amount conversion unit 323, an inference unit 324, and an output processing unit 325.

The frame selection unit 311 selects a target frame (corresponding to the captured image 103) from a learning target video 310 output from the inspection camera 101, and outputs the selected learning target frame to the edge cutting unit 312. For example, the target frame is selected at a timing based on a certain time interval or according to an instruction from the inspector, an engineer, or the like. Furthermore, a plurality of consecutive target frames within a set period may be selected from the learning target video 310.

The edge cutting unit 312 cuts an edge portion from the target frame selected by the frame selection unit 311 based on an input from the inspector or the like, assigns a normal/defect attribute to the cut edge portion, and outputs the edge portion to the feature learning unit 313. The normal/defect attribute can also be referred to as a label. In this manner, it is desirable to narrow down points suspected as defects in order to improve learning efficiency. An edge portion having a certain length or more is defined as a defective edge portion, and the normal or defect attribute is assigned at the time of learning. The defective edge portion is an edge having a certain length or more and thus having a possibility of being a crack.

The feature learning unit 313 trains the feature model 315 based on information regarding the edge portion cut by the edge cutting unit 312. The feature model 315 (an example of a training target model) is a machine learning model that extracts and digitizes a feature of an image of the edge portion (computes a feature amount). For example, a computation model including an encoder that expresses the feature of the image (input series) of the edge portion by a numerical vector and a decoder that converts the numerical vector into a numerical string can be used as the feature model 315.

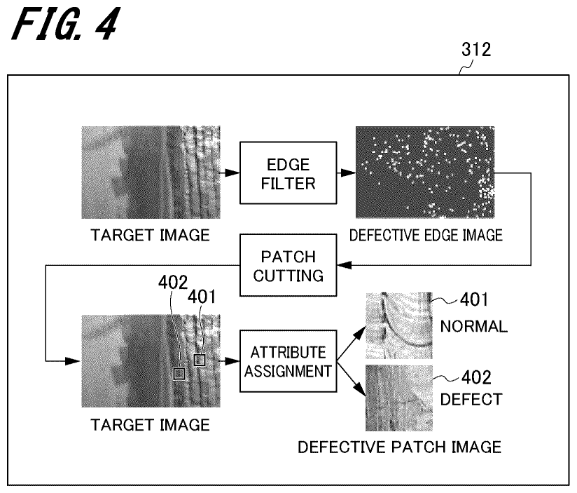

The identification learning unit 314 trains the identification model 316 based on the feature amount of the image of the edge portion input from the feature learning unit 313 and the normal/defect attribute. The identification model 316 (an example of a training target model) is a machine learning model that identifies (determines) whether or not the edge portion having the input feature amount is a crack based on the normal/defect attribute. For example, the identification model 316 can be configured using a convolutional neural network (CNN). As described above, the feature learning unit 313 performs feature amount conversion processing, but it is difficult to identify a crack based on simple criteria. Therefore, effective information is automatically extracted from a patch image (see FIG. 4) using a neural network technology such as the CNN to identify a crack.

The frame selection unit 321 selects a target frame (corresponding to the inspection image 201) from an evaluation target video 320 output from the inspection camera 101, and outputs the selected target frame to the edge cutting unit 312. For example, the target frame is selected at a timing based on a certain time interval or according to an instruction from the inspector or the like. Further, a plurality of consecutive target frames within a set period may be selected from the evaluation target video 320.

The edge cutting unit 322 cuts an edge portion from the target frame selected by the frame selection unit 321, assigns a normal/defect attribute to the cut edge portion, and outputs the edge portion to the feature amount conversion unit 323.

The feature amount conversion unit 323 digitizes a feature of an image of the edge portion cut by the edge cutting unit 322 using the trained feature model 315 to obtain a feature amount (feature amount conversion), and outputs the feature amount to the inference unit 324.

The inference unit 324 infers (determines) whether or not the edge portion is a crack by using the identification model 316 for the feature amount of the image of the edge portion input from the feature amount conversion unit 323, and outputs an inference result to the output processing unit 325.

The output processing unit 325 performs output processing based on the inference result input from the inference unit 324. For example, in a case where there is a crack in the target frame, the output processing unit 325 indicates and outputs the corresponding portion in the target frame with the contour line 211, the determination assistance output 212, and the like.

In FIG. 3, the training phase (the frame selection unit 311 to the identification learning unit 314) and the inference phase (the frame selection unit 321 to the output processing unit 325) of the crack determination AI 108 are implemented by one AI. However, the training phase and the inference phase may be separately implemented by AIs.

Here, details of processing in the edge cutting unit 312 of the crack determination AI 108 will be described with reference to FIG. 4. The edge cutting unit 312 operates in the training phase.

FIG. 4 is a diagram illustrating an example of processing in the edge cutting unit 312 of the crack determination AI 108.

The edge cutting unit 312 inputs the target frame (described as “target image” in FIG. 3) selected by the frame selection unit 311 to an edge filter, and generates an image (defective edge image) in which the defective edge portion having a predetermined length or more is highlighted in the target frame by filtering processing. The defective edge portion may be a defect, but is not classified as either a defect or a normal portion at this stage.

Next, the edge cutting unit 312 cuts the patch image (a small fragment of an image) corresponding to the defective edge portion from the target image based on the defective edge image. FIG. 4 illustrates an example in which patch images 401 and 402 are cut in the target image. The patch images correspond to the “edge portions” described in FIG. 3.

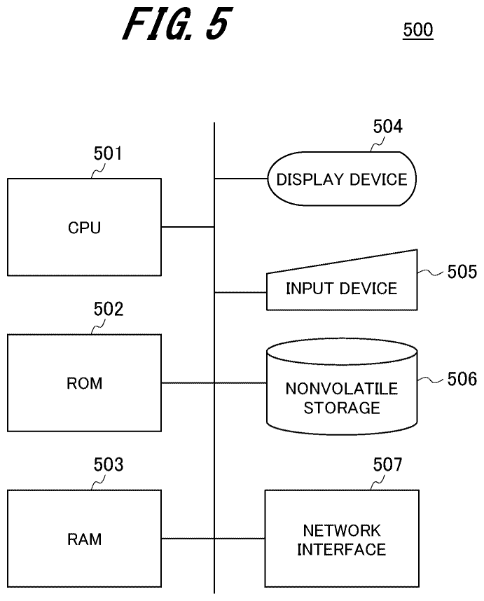

Next, the edge cutting unit 312 performs processing of assigning the normal or defect attribute to the cut patch image based on an input content from the inspector or the like. Whether the cut patch image is normal or defective is visually determined by the inspector or the like. The inspector or the like clicks the patch image in the target image by, for example, an input device 505 (see FIG. 5) and inputs a result of determining whether the patch image is normal or defective for the patch image. In the present embodiment, it is assumed that the defect attribute is assigned to the patch image for which it is determined that there is a crack. The normal or defect attribute is an example of a ground truth label. The “normal” attribute indicates that there is no crack in the patch image, and the “defect” attribute indicates that there is a crack in the patch image.

In the example of FIG. 4, the normal attribute is assigned to the patch image 401, and the defect attribute is assigned to the patch image 402. The patch image 402 to which the “defect” attribute is assigned is a defective patch image having a high possibility of corresponding to an abnormal portion such as a crack.

Once a certain amount of the patch images and normal/defect attribute information has been accumulated, the normal/defect attribute may be automatically assigned to a newly cut patch image by a machine learning model that learns the data.

On the other hand, the edge cutting unit 322 operating in the inference phase performs processing using the edge filter of the edge cutting unit 312 and processing up to patch cutting.

Next, a hardware configuration of the pseudo crack image generation computer 105, the crack determination AI 108, and the computer (not illustrated) in the crack inspection system according to one embodiment of the present invention will be described with reference to FIG. 5.

FIG. 5 is a block diagram illustrating a hardware configuration example of a calculator used in the crack inspection system according to the present embodiment. A calculator 500 illustrated in FIG. 5 is an example of hardware used as the computer.

The calculator 500 includes a central processing unit (CPU) 501, a read only memory (ROM) 502, and a random access memory (RAM) 503 that are connected to a system bus. The calculator 500 further includes a display device 504, the input device 505, a nonvolatile storage 506, and a network interface 507. The CPU 501 is an example of a computation device, and the ROM 502 and the nonvolatile storage 506 are examples of storage devices.

The CPU 501 reads a program code of software for implementing each function according to the present embodiment from the ROM 502, loads the program code into the RAM 503, and executes the program code. Variables, parameters, and the like generated during computation processing of the CPU 501 are temporarily written to the RAM 503, and the variables, parameters, and the like are appropriately read by the CPU 501. Instead of the CPU 501, another processor such as a micro processing unit (MPU) may be used.

For example, in the pseudo crack image generation computer 105, the CPU 501 executes the program code read from the ROM 502, thereby implementing generation of the pseudo crack image. In addition, in the crack determination AI 108, the CPU 501 executes the program code read from the ROM 502, thereby implementing the functions of the respective functional blocks (FIG. 3) of the crack determination AI 108.

The display device 504 is a monitor such as a liquid crystal display, and displays a graphical user interface (GUI) screen, a result of processing performed by the CPU 501, and the like. For example, the display device 504 displays the pseudo crack image 106 illustrated in FIG. 1 and a defect inspection result (the contour line 211, the determination assistance output 212, and the like) illustrated in FIG. 2. The input device 505 generates an input signal according to a user operation and outputs the input signal to the CPU 501. As the input device 505, for example, a mouse, a keyboard, or the like is used, and the inspector or the like can input information and instructions by operating the input device 505. The display device 504 and the input device 505 may be integrally implemented as a touch panel.

The nonvolatile storage 506 is an example of a recording medium, and can store data used by a program, data obtained by executing the program, and the like. For example, a system of the crack determination AI 108, and the feature model 315 and the identification model 316 used in the crack determination AI 108 are stored in the nonvolatile storage 506. In addition, the pseudo crack image 106 and the crack image 107 generated by the pseudo crack image generation computer 105 are stored in the nonvolatile storage 506. Further, an operating system (OS) or a program executed by the CPU 501 may be recorded in the nonvolatile storage 506. As the nonvolatile storage 506, a hard disk drive (HDD), a solid state drive (SSD), an optical disk using light or magnetism, a semiconductor memory card, or the like is used.

As the network interface 507, for example, a communication device such as a network interface card (NIC) is used. The network interface 507 can transmit and receive various types of data to and from an external device via a communication network such as a local area network (LAN), a dedicated line, or the like. The captured image 103 (the learning target video 310 in FIG. 4) and the inspection image 201 (the evaluation target video 320 in FIG. 4) may be input to the crack determination AI 108 by the network interface 507.

Each block may be selectively provided according to the function and purpose of use of each computer or the like described above. For example, in the crack determination AI 108 and the computer (not illustrated) in the system, the display device 504 and the input device 505 may be omitted.

As described above, a machine learning method of the crack determination AI in the remote inspection system according to the present embodiment is a machine learning method of the crack determination AI executed by a calculator (500) including a computation device (such as the CPU 501) that executes a program and a storage device (such as the ROM 502) that stores the program.

The machine learning method of the crack determination AI includes: processing of acquiring, by the computation device, a data set including a crack image (107) and a ground truth label regarding the presence or absence of a crack; and processing of inputting, by the computation device, the crack image (107) and the ground truth label to a training target model (such as the identification model 316) to train the training target model (such as the identification model 316) so as to determine the presence or absence of a crack for an inspection target image (201).

Here, the crack image (107) is an image generated through a process of generating a pseudo crack image (106) by randomly determining a value of at least one element among elements defining a shape of a pseudo crack using a random number and a process of superimposing the pseudo crack image (106) on an image (103) of a real subject.

In the machine learning method of the crack determination AI configured as described above, machine learning is performed using a large number of realistic and authentic-looking crack images. The crack image is created by generating the pseudo crack image by randomly determining the value of the element defining the shape of the pseudo crack using the random number, and superimposing the pseudo crack image on the image of the real subject. Therefore, a large number of realistic and authentic-looking crack images are generated in a short time. By training the training target model using a large number of such crack images, the training of the crack determination AI can be efficiently and easily performed.

In addition, a crack inspection method in the remote inspection system according to the present embodiment is a crack inspection method by a calculator (500) including a computation device (such as the CPU 501) that executes a program and a storage device (such as the ROM 502) that stores the program.

The crack inspection method includes processing of acquiring, by the computation device, an inspection target image (201), and processing of determining, by the computation device, the presence or absence of a crack in the inspection target image (201) using a trained model (such as the identification model 316).

Here, the trained model (such as the identification model 316) is trained to determine the presence or absence of a crack for the inspection target image (201) using a crack image (107) obtained by superimposing a pseudo crack image (106) on an image (103) of a real subject and a ground truth label regarding the presence or absence of a crack.

The crack image (107) is an image generated through a process of generating the pseudo crack image (106) by randomly determining a value of at least one element among elements defining a shape of a pseudo crack using a random number and a process of superimposing the pseudo crack image (106) on the image (103) of the real subject.

In the crack inspection method configured as described above, the presence or absence of a crack is determined for the inspection target image using the trained model (crack determination AI 108) trained based on a large number of realistic and authentic-looking crack images. Therefore, crack inspection accuracy can be improved.

In addition, by using the trained model trained in this way, it is possible to assist crack determination made by the inspector at an actual inspection site and reduce a burden on the inspector.

Further, the generated large number of crack images can be utilized for crack inspection training of the inspector, which simulates an actual inspection.

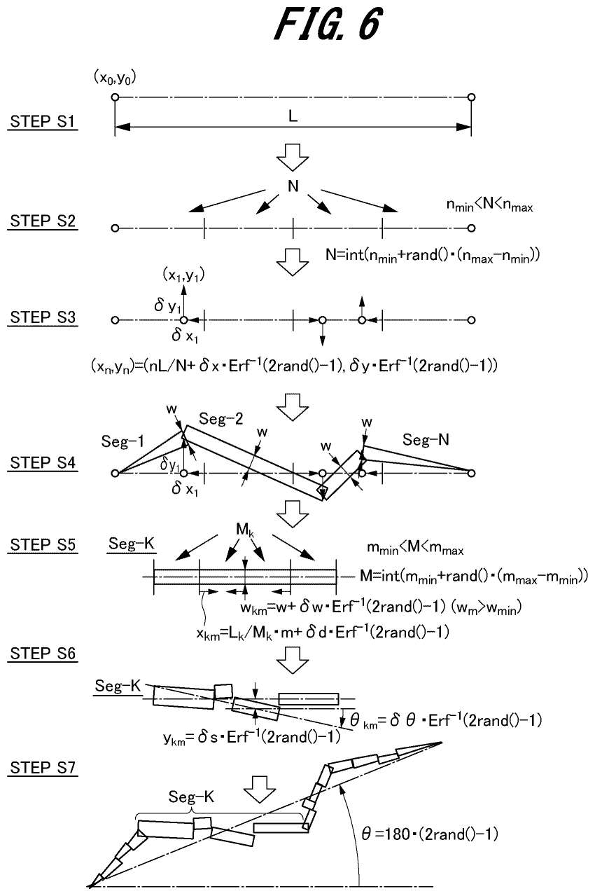

Here, a flow of processing of generating the pseudo crack image based on the crack shape condition and the variation condition illustrated in FIG. 1 will be described with reference to FIG. 6.

FIG. 6 is a diagram illustrating an example of a flow of processing of generating the pseudo crack image by the pseudo crack image generation computer 105 based on the crack shape condition and the variation condition.

In step S1, the pseudo crack image generation computer 105 determines an approximate position and an approximate size (length) of the crack by specifying a crack start point (x₀, y₀) on a two-dimensional coordinate system and a global length L of the crack. Here, the term “global” refers to the entire crack. The crack start point (x₀, y₀) corresponds to a position at which the pseudo crack is superimposed on the captured image. As for an angular direction, it is assumed that a rotation angle is designated later, and first, an extension direction along a reference axis (here, an x axis) is assumed. A global extension direction of the crack is basically defined as a direction of a straight line connecting the crack start point and a crack end point.

In step S1 and the subsequent steps, an operation of specifying the value of the element defining the shape of the crack without using the random number may be performed by the pseudo crack image generation computer 105 according to a predetermined rule, or may be manually performed by the inspector or the like. Examples of the corresponding element include the global length L of the crack, an average opening width w, and the crack start point (x₀, y₀). As an example, a plurality of different values may be prepared in advance for the global length L of the crack, and the computer may sequentially or randomly select the values. The same applies to the average opening width and the crack start point.

In step S2, the pseudo crack image generation computer 105 specifies the number N of bending segments of the crack and designates an approximate zigzag frequency. The bending segment is a segment from one bending point to the next bending point of the crack, or a segment between the crack start point or the crack end point and the bending point. Here, the zigzag frequency refers to the number of deviations (the number of times the crack is bent) in a direction perpendicular to the global extension direction of the crack, and is designated based on the number N of bending segments divided at the bending point. In FIG. 6, one crack includes four bending segments.

Here, a minimum value nₘᵢₙ and a maximum value nₘₐₓ of the number N of bending segments are designated such that the number N of bending segments is also randomly determined, and the number N of bending segments is randomly determined within the range. In the present embodiment, the number N of bending segments is determined using a uniform random number generation function rand( ) as shown in the following Formula (1). rand( ) takes any value in a range of 0 to 1.

An int function is a function that rounds down a decimal number to the nearest integer.

$$\begin{matrix}[ Formula 1 ] & \\ N = int ( {n}_{min} + rand ( ) \cdot ( {n}_{max} - {n}_{min} ) ) where {n}_{min} < N < {n}_{max} & ( 1 )\end{matrix}$$

An arbitrary variable is included in ( ) of rand( ). Although a seed value for determining a random number sequence is assumed as a variable, it is not necessary to designate the seed value. In general, by changing a random number coefficient according to the seed value, a value of rand( ) becomes more random.

In step S3, the pseudo crack image generation computer 105 randomly varies a boundary position between the bending segments. In the case of a crack including N bending segments, the number of boundaries is (N−1). As shown in the following Formula (2), as coordinate values of an n-th boundary coordinates (xₙ, yₙ), the x coordinate is varied from a coordinate value obtained by equally dividing the entire crack, and the y coordinate is varied from zero, by using normally distributed random numbers with standard deviations δₓ and δ_{y}, respectively. The standard deviation δx is a standard deviation of a bending amplitude in the extension direction. The bending amplitude is a displacement amount in a direction perpendicular to the global extension direction of the crack. The standard deviation δy is a standard deviation of a bending amplitude in a width direction. The normally distributed random number is generated by an inverse error function Erf⁻¹ (2rand( )−1) using a uniform random number in a range of +1 as an argument.

$$\begin{matrix}[ Formula 2 ] & \\ ( {x}_{n} , {y}_{n} ) = ( nL / N + δ x \cdot {Erf}^{- 1} ( 2 rand ( ) - 1 ) , δ y \cdot {Erf}^{- 1} ( 2 rand ( ) - 1 ) ) & ( 2 )\end{matrix}$$

Here, the coordinate values of the n-th boundary coordinates (xₙ, yₙ) are varied using the normally distributed random numbers, and the n-th boundary coordinates may be displaced by a predetermined displacement amount. The predetermined displacement amount may be uniformly the same value regardless of the number of bends of the crack, or may be a value corresponding to the number of bends.

In step S4, for the bending segments continuing so as to connect the bending points determined in this manner, the pseudo crack image generation computer 105 assumes that a shape of a bending segment on each of both end sides of the crack is a triangle whose vertex is at an end, and a shape of a bending segment therebetween is a quadrangle (for example, a rectangle). Then, the pseudo crack image generation computer 105 specifies a base of the triangle and a width of the quadrangle as w, and designates an approximate shape of the crack. The width w of the quadrangle is a length of a side in a direction perpendicular to the extension direction of the crack, and corresponds to the average opening width of the crack. By forming the bending segments at both ends of the crack into triangles in this manner, it is possible to generate the pseudo crack in a more realistic crack shape.

As shown in step S7, in the triangular bending segments at both ends of the crack, a trapezoidal divided segment is generated by dividing the bending segment in consideration of shear displacement.

In step S5, the pseudo crack image generation computer 105 further randomly divides each bending segment determined in this way, and varies the width w of the divided segment after the division.

The divided segment is also referred to as “shearing segment”. In FIG. 6, a k-th bending segment Seg-K is divided into four divided segments (shearing segments).

For example, in the k-th bending segment Seg-K, a minimum value mₘᵢₙ and a maximum value mₘₐₓ of the number M of divided segments are designated, and the number Mₖ of divided segments is varied using a uniform random number therebetween. The number Mₖ of divided segments is the number of segments when the k-th bending segment Seg-K is divided. In the present embodiment, the number M of divided segments in an arbitrary bending segment is determined using the uniform random number generation function rand( ) as shown in the following Formula (3). The minimum value mₘᵢₙ and the maximum value mₘₐₓ Of the number M of divided segments do not have to be the same as the minimum value nₘᵢₙ and the maximum value nₘₐₓ of the number N of bending segments described above.

$$\begin{matrix}[ Formula 3 ] & \\ M = int ( {m}_{min} + rand ( ) \cdot ( {m}_{max} - {m}_{min} ) ) where {m}_{min} < M < {m}_{max} & ( 3 )\end{matrix}$$

The pseudo crack image generation computer 105 varies an x coordinate value of a division point in a longitudinal direction when divided in this way by using a normally distributed random number with a variation δd as a standard deviation while fixing both ends of the bending segment Seg-K as shown in the following Formula (4). The variation δd corresponds to a standard deviation of a length of the shearing segment. xₖₘ represents an x coordinate value of a division point of the m-th divided segment in the k-th bending segment Seg-K in the longitudinal direction. Here, the x coordinate is a coordinate having the extension direction of the bending segment as a coordinate axis.

$$\begin{matrix}[ Formula 4 ] & \\ {x}_{km} = {L}_{k} / {M}_{k} \cdot m + δ d \cdot {Erf}^{- 1} ( 2 rand ( ) - 1 ) & ( 4 )\end{matrix}$$

Lₖ is a length of the k-th bending segment Seg-K. Lₖ is equally divided into M, an m-th division point is set as a start point, and a variation is applied to a position of the start point. Mₖ is the number of divided segments after dividing the k-th bending segment Seg-K.

In addition, the pseudo crack image generation computer 105 also varies the width w for each divided segment by using a normally distributed random number with a variation δw as a standard deviation, as shown in the following Formula (5). The variation δw corresponds to a standard deviation of an opening width of the shearing segment. wₖₘ represents a width of the m-th divided segment in the k-th bending segment Seg-K.

$$\begin{matrix}[ Formula 5 ] & \\ {w}_{km} = w + δ w \cdot {Erf}^{- 1} ( 2 rand ( ) - 1 ) where {w}_{km} > {w}_{min} & ( 5 )\end{matrix}$$

In step S6, the pseudo crack image generation computer 105 causes the shear displacement to occur in a direction perpendicular to the longitudinal direction of the corresponding bending segment for each divided segment obtained by further dividing each bending segment. A shear displacement amount y is set such that random shear displacement occurs using a normally distributed random number with a variation δs as an input as shown in the following Formula (6). The variation δs corresponds to a standard deviation of shearing segment displacement in the width direction. yₖₘ represents a shear displacement amount of the m-th divided segment in the k-th bending segment Seg-K.

$$\begin{matrix}[ Formula 6 ] & \\ {y}_{km} = δ s \cdot {Erf}^{- 1} ( 2 rand ( ) - 1 ) & ( 6 )\end{matrix}$$

In addition, the pseudo crack image generation computer 105 randomly rotates each divided segment (shear segment) of any bending segment generated as described above in a direction of a designated angle θₖₘ. A rotation angle is set such that rotation by a random rotation amount is made by using a normally distributed random number with a standard deviation 80 as an input as shown in the following Formula (7). The standard deviation δθ is a standard deviation of a rotation angle (displacement angle) of the shear segment with respect to the extension direction of the bending segment.

$$\begin{matrix}[ Formula 7 ] & \\ {θ}_{km} = δ θ \cdot {Erf}^{- 1} ( 2 rand ( ) - 1 ) & ( 7 )\end{matrix}$$

θₖₘ represents a rotation angle of the m-th divided segment in the k-th bending segment Seg-K. The rotation angle is a rotation amount of the divided segment with respect to the extension direction of the bending segment. In the present embodiment, it is assumed that each divided segment (shear segment) is rotated about the center of gravity, but the divided segment may be rotated about another position (such as a start point) of the divided segment.

In step S7, the pseudo crack image generation computer 105 randomly rotates the crack occurring as described above in the direction of the designated angle θ as shown in the following Formula (8). θ represents the global extension direction of the crack, that is, a rotation angle with respect to the x axis (a length direction of the crack) of the two-dimensional coordinate system in step S1. The rotation angle is an example of random rotation around the crack start point in any direction within 360° using a uniform random number. However, as in a weld bead portion, a stress that causes a crack may have a directional tendency. Therefore, it is assumed that a variation range of the rotation angle is determined for each subject in some cases.

$$\begin{matrix}[ Formula 8 ] & \\ θ = 180 \cdot ( 2 rand ( ) - 1 ) & ( 8 )\end{matrix}$$

In the processing of steps S1 to S7 described above, it is sufficient if the pseudo crack image 106 is generated by randomly determining a value of at least one condition among the crack shape conditions (elements defining the shape of the pseudo crack) using a random number.

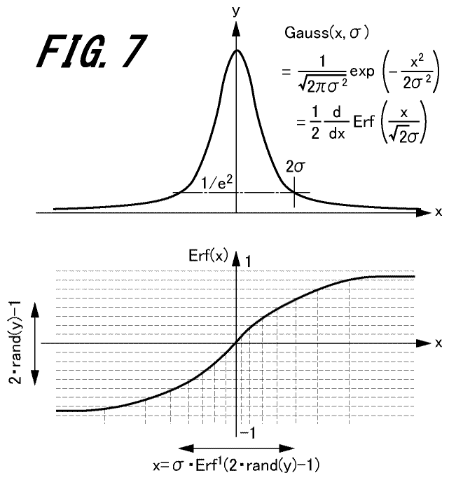

The basis of the formula for the normally distributed random number will be described with reference to FIG. 7.

The normal distribution is expressed by a so-called Gaussian function having squared terms of input arguments x and o in an exponential function as shown in the following Formula (9), and is a distribution as shown in the graph on the upper side of FIG. 7. σ is a standard deviation.

$$\begin{matrix}[ Formula 9 ] & \\ Gauss ( x , σ ) = \frac{1}{\sqrt{2 {πσ}^{2}}} exp ( - \frac{{x}^{2}}{2 {σ}^{2}} ) = \frac{1}{2} \frac{d}{dx} Erf ( \frac{x}{\sqrt{2} σ} ) & ( 9 )\end{matrix}$$

When it is desired to cause a numerical value to have a variation based on a normal distribution, the origin of the graph is assumed to coincide with an average value, and the standard deviation σ is designated, whereby an occurrence frequency of the average value is the highest, and a variation based on the Gaussian function can be implemented. In the case of rand( ), a variation of a value occurring in a range of 0 to 1 is uniform.

A function obtained by integrating the Gaussian function in an x-axis direction is known as an error function Erf(x), and is a function asymptotically approaching ±1 as illustrated on the lower side of FIG. 7. Therefore, when a vertical axis value indicating the error function Erf(x) is designated by a uniform random number generation function (2rand(y)−1) uniformly varying in a range of ±1 and the corresponding x coordinate value is obtained by an inverse function of the error function Erf(x), the obtained x coordinate value becomes a normally distributed random number. Here, the x coordinate value is obtained by x=σ·Erf⁻¹ (2·rand (y)−1).

As described above, the crack image generation method in the remote inspection system according to the present embodiment is a crack image generation method of generating a crack image by a calculator (500) including a computation device (such as the CPU 501) that executes a program and a storage device (such as the ROM 502) that stores the program.

The crack image generation method includes: processing of generating, by the computation device, a pseudo crack image (106) by randomly determining a value of at least one element among elements defining a shape of a pseudo crack using a random number; and processing of generating, by the computation device, a crack image (107) by superimposing the pseudo crack image (106) on an image (103) of a real subject.

According to the present embodiment having such a configuration, the pseudo crack image is generated by randomly determining a value of at least one element among the elements defining the shape of the pseudo crack using a random number. Then, by using the pseudo crack image, it is possible to generate a large number of realistic and authentic-looking crack images in a short time.

In addition, in the crack image generation method of the present embodiment, the elements defining the shape of the pseudo crack include a global length (L) of the pseudo crack, an average opening width (w) of the pseudo crack, the number (N) of bending segments of the pseudo crack, a global extension direction (θ) of the pseudo crack, and a position (x₀, y₀) at which the pseudo crack is superimposed on the image of the real subject. The computation device can be configured to randomly determine values of one or more elements among the number (N) of bending segments of the pseudo crack and the global extension direction (θ) of the pseudo crack using a random number.

According to the present embodiment having such a configuration, it is possible to generate a large number of pseudo crack images in which at least one of the number of bending segments and the global extension direction of the pseudo crack is randomly determined.

In addition, in the crack image generation method of the present embodiment, the elements defining the shape of the pseudo crack further include a boundary position (xₙ, yₙ) between adjacent bending segments of the pseudo crack. The computation device can be further configured to randomly determine the boundary position (xₙ, yₙ) between adjacent bending segments using a random number.

According to the present embodiment having such a configuration, it is possible to generate a large number of pseudo crack images in which the boundary position between adjacent bending segments of the pseudo crack is randomly determined.

In addition, in the crack image generation method of the present embodiment, the elements defining the shape of the pseudo crack further include the number (M) of divided segments obtained by dividing the bending segment, a displacement amount (xₖₘ, yₖₘ) of the boundary position between the divided segments connecting division points of the bending segment, and a rotation angle (θₖₘ) of the divided segment with respect to the extension direction of the bending segment. In addition, the computation device may randomly determine values of one or more elements among the number (M) of divided segments of the bending segment, the displacement amount (xₖₘ, yₖₘ) of the boundary position between the divided segments, and the rotation angle (θₖₘ) of the divided segment with respect to the extension direction of the bending segment using a random number.

According to such a configuration, it is possible to generate a large number of pseudo crack images in which at least one of the number of divided segments of the bending segment, the displacement amount of the boundary position between the divided segments, and the rotation angle of the divided segment with respect to the extension direction of the bending segment is randomly determined.

Furthermore, in the crack image generation method of the present embodiment, the computation device defines the values of the number (N) of bending segments of the pseudo crack, the global extension direction (θ) of the pseudo crack, and the number (M) of divided segments of the bending segment using uniform random numbers within a predetermined range. In addition, the computation device varies a predetermined standard deviation with a normally distributed random number to define a deviation with respect to values of the boundary position (xₙ, yₙ) between the bending segments, the displacement amount (xₖₘ, yₖₘ) of the boundary position between the divided segments, and the rotation angle (θₖₘ) of the divided segment with respect to the extension direction of the bending segment.

According to the present embodiment having such a configuration, the number of bending segments of the pseudo crack, the global extension direction of the pseudo crack, and the number of divided segments of the bending segment vary using uniform random numbers within a predetermined range. Further, a deviation from each average value of the boundary position between the bending segments, the displacement amount of the boundary position between the divided segments, and the rotation angle of the divided segment with respect to the extension direction of the bending segment can be varied using a normally distributed random number. By randomly determining the values of the elements defining the shape of the pseudo crack by using such random numbers, it is possible to generate a large number of realistic and authentic-looking crack images in a short time.

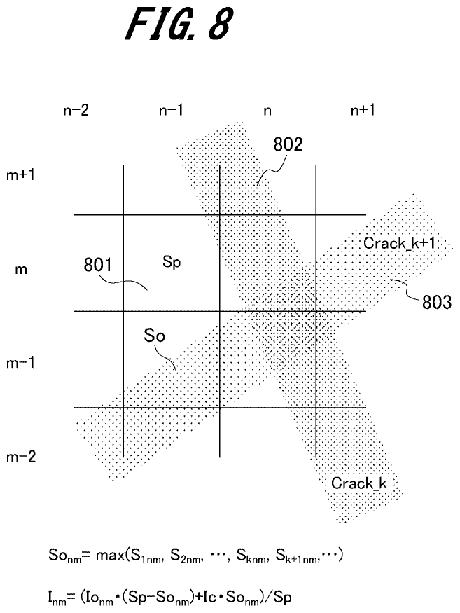

FIG. 8 is a diagram for describing a method of determining the luminance when the pseudo crack image having an assumed crack shape is superimposed on the captured image without a crack as described above.

A grid illustrated in FIG. 8 conceptually illustrates an enlarged view of arrangement of a plurality of pixels 801 included in the image sensor mounted on the inspection camera 101. Addresses of the pixels are arranged horizontally as n−2, n−1, n, n+1, and the like, and vertically as m−2, m−1, m, m+1, and the like. In such a pixel arrangement, a k-th crack pattern 802 (Crack_k) and a (k+1)-th crack pattern 803 (Crack_k+1) are geometrically projected. The crack patterns 802 and 803 correspond to bending segments or shear segments of the pseudo crack image 106.

An actual crack is generally a gap having a V-shaped cross section and formed in an object, and it is assumed that an opening width thereof is larger than a wavelength of visible light and a depth thereof is larger than the opening width. Therefore, at least initially, it is assumed that light incident on the crack is absorbed into the crack without being reflected. Therefore, a crack luminance Ic in a case where the crack pattern is sufficiently large can be assumed to be a luminance (dark output luminance) when light does not enter the image sensor.

However, in the case of observing an opening width of a crack to be inspected at an image formation magnification of the inspection camera generally used for remote visual inspection of a nuclear reactor, the opening width geometrically projected at the image formation magnification is smaller than a pixel pitch. Therefore, it is assumed that a luminance of the crack observed at this time is higher than the above-described crack luminance Ic. A geometric projection luminance Iₙₘ Of a pixel (n, m) of an image obtained by the image sensor of the inspection camera 101 at this time is determined by Formula (10).

$$\begin{matrix}[ Formula 10 ] & \\ {I}_{nm} = \{ {Io}_{nm} \times ( Sp - {So}_{nm} ) + Ic \times {So}_{nm} \} / Sp & ( 10 )\end{matrix}$$

Here, Sp is a pixel area, and Soₙₘ is a maximum area (Soₙₘ=max (S_{1 nm}, S_{2 nm}, . . . , Sₖₙₘ, S_{k+1 nm}, . . . )) of a crack projection overlapping in the pixel (n,m). In a case where a plurality of cracks overlap each other, a calculation result for a crack whose overlapping area is the largest is substituted without superimposing the luminance. That is, the geometric projection luminance Iₙₘ is obtained as a weighted average luminance based on an area ratio between an area of a luminance Ioₙₘ and an area of the crack luminance Ic in the pixel (n,m) before crack superimposition. The area of the crack projection overlapping in the pixel (n,m) is different for each crack projection.

As described above, in the crack image generation method of the present embodiment, a computation device (such as the CPU 501) determines a luminance of a pixel of an image (103) of a real subject on which a pseudo crack image (106) is superimposed based on {Io×(Sp−So)+Ic×So}/Sp, in which So represents an area by which a pseudo crack superimposed on a quadrangle of the pixel having a side length corresponding to a relative pixel pitch in projection of the image (103) of the subject onto the real subject at the corresponding pixel position on the projection, and a quadrangle of the pixel overlap each other at each pixel position of the image (103) of the real subject on which the pseudo crack image (106) is superimposed, Sp represents an area of the pixel, Io represents a luminance of the pixel before the pseudo crack is superimposed, and Ic represents a luminance of the pixel of the pseudo crack to be superimposed.

In the present embodiment having such a configuration, a luminance (Iₙₘ) of the pixel on which the pseudo crack is superimposed in the image of the real subject is obtained as a weighted average luminance based on an area ratio between a luminance (Ic) of a portion on which the pseudo crack is superimposed in the pixel and a luminance (Ioₙₘ) of a portion on which the pseudo crack is not superimposed in the pixel. As a result, it is possible to create a crack image according to a pixel luminance of the image of the real subject.

Therefore, a more realistic and authentic-looking crack image can be generated.

However, in practice, the final crack image further changes according to conditions such as the image formation magnification and defocus of the optical system. Therefore, image formation calculation based on an optical theory is required.

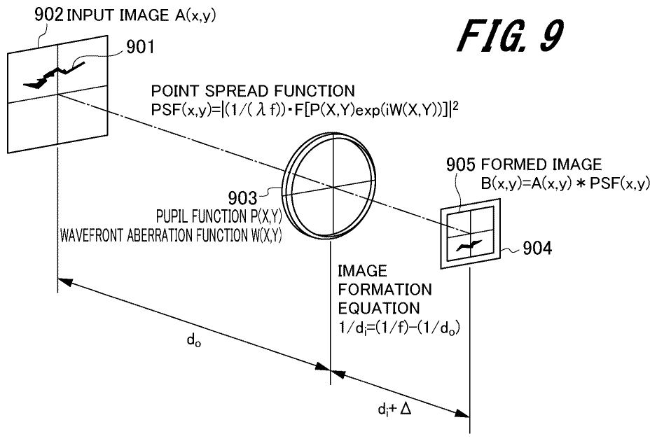

FIG. 9 is a diagram illustrating an optical model for the image formation calculation.

It is assumed that an input image 902 (corresponding to the inspection image) on which a generated pseudo crack image 901 is superimposed is disposed at a predetermined object distance dₒ in an actual size from an image formation lens 903 satisfying conditions of a predetermined focal length f and an effective diameter. In addition, it is assumed that the input image 902 is formed as a formed image 905 on an image sensor 904 disposed at an image distance dᵢ calculated from an image formation equation shown in the following Formula (11). At this time, a size of the pseudo crack image 901 is reduced by a magnification of dᵢ/dₒ and formed.

$$\begin{matrix}[ Formula 11 ] & \\ 1 / {d}_{i} = ( 1 / f ) - ( 1 / {d}_{0} ) & ( 11 )\end{matrix}$$

At this time, it is assumed that there is a wavefront aberration W (X, Y) due to defocus A or the like in the optical system. In this case, a point spread function PSF (x, y) forming an image to be formed on the image sensor 904 is expressed by the following Formula (12) with a pupil function P(X, Y) determined from the conditions of the effective diameter and a transmittance of the image formation lens 903. The pupil function outputs 1 within an opening radius and outputs 0 otherwise.

$$\begin{matrix}[ Formula 12 ] & \\ PSF ( x , y ) = {\vert ( 1 / ( λ f ) ) F [ P ( X , Y ) exp ( iW ( X , Y ) ) ] \vert}^{2} & ( 12 )\end{matrix}$$

Here, the point spread function PSF is an intensity distribution of an image of a point light source formed on the image sensor 904 in a case where there is a point light source on the input image 902. In addition, λ represents a wavelength of a light source (not illustrated), F[ ] represents a two-dimensional Fourier transform operation by an action of Fraunhofer diffraction in the image formation lens 903, and i represents an imaginary unit. Furthermore, (x, y) represents two-dimensional coordinates on the image sensor 904 and on an object surface having a geometric projection relationship in an image formation relationship. (X, Y) represents two-dimensional coordinates on a pupil plane of the image formation lens 903. An image obtained by imaging the object surface is the inspection image (input image 902) and corresponds to a position of a virtual wall.

The point spread function PSF is superimposed on the image sensor 904 corresponding to each point on the object surface to form an image. Therefore, when the input image 902 is A(x, y), a formed image B(x, y) is obtained by Formula (13). Here, “*” represents an overlap integral.

$$\begin{matrix}[ Formula 13 ] & \\ B ( x , y ) = A ( x , y ) * PSF ( x , y ) & ( 13 )\end{matrix}$$

As described above, in the crack image generation method in the remote inspection system according to the present embodiment, a computation device sets a projection of an image of a real subject on which a pseudo crack image (901) is superimposed onto the real subject as a virtual subject (input image 902). Then, the computation device generates a crack image obtained by superimposing the pseudo crack image on the image of the real subject by calculating an optical image (formed image 905) of the virtual subject formed on an image sensor (904) of a camera based on an optical theory according to optical conditions of the camera that has imaged the real subject.

In such a crack image generation method of the present embodiment, it is possible to generate a more realistic and authentic-looking crack image by reflecting the optical conditions (a camera function, an illumination condition, and the like) of the camera in the crack image. Therefore, by training a training target model using a large number of such crack images, crack determination accuracy of the trained model can be improved.

In addition, by generating the crack image based on the optical conditions (the camera function, the illumination condition, and the like) of the camera, it is possible to simulate in advance an effect of shortening an inspection time due to a difference in functions and conditions. Therefore, work efficiency can be efficiently improved.

In this way, in the present embodiment, it is possible to generate a realistic crack image in which the actual size (a distance to the object surface or the like) and a defocus condition are taken into consideration. Therefore, in the present embodiment, AI training equivalent to training using a crack image obtained by imaging an actually cracked subject can be performed by using the crack image on which the pseudo crack image is superimposed.

Furthermore, in the present embodiment, it is possible to cause the crack determination AI 108 to efficiently perform machine learning by generating a large number of crack images using random numbers. Therefore, crack determination performance can be improved.

In the example illustrated in FIG. 9, the wavefront aberration W and the pupil function P are computed separately, but the wavefront aberration may be included in the pupil function P in the form of a phase.

In the above description of the optical theory in image formation, a case where a wavelength λ of the light source corresponds to monochromatic light is assumed, but the present invention is not limited to this example. For example, it is also possible to generate a color image by assuming wavelengths of three primary colors (red, blue, and green) which are basic colors of light, performing the above image formation calculation at the respective wavelengths, and displaying each calculated luminance as a color image.

As described above, in the crack image generation method of the present embodiment, the image of the real subject is a color image, and the computation device calculates a pixel luminance of the image of the real subject after the pseudo crack image is superimposed for light of each of the basic colors, and determines the pixel luminance based on a calculation result for each basic color.

According to such a configuration, the crack image can be generated as a color image, and a crack, an alert indicator, or the like can be superimposed on the color image. Therefore, visibility of the crack, the alert indicator, and the like for the inspector is improved.

In the above-described embodiment, the correctness of the crack determination result may be fed back to the crack determination AI 108. For example, in a case where it becomes clear that the crack is not correctly determined in a process of confirming an effect of the machine learning by the inspector, the correctness of the crack determination result is fed back to the crack determination AI 108. As a result, the crack determination AI 108 performs relearning based on the crack determination result, so that the crack determination accuracy is improved.

As described above, the present invention is not limited to the above-described embodiment, and it goes without saying that various other modified examples and application examples can be taken without departing from the gist of the invention described in the claims. For example, the above-described embodiment has been described in detail and specifically in order to describe the present invention in an easy-to-understand manner, and the present invention is not necessarily limited to those including all the described components. In addition, it is also possible to add, replace, or delete other components for a part of the configuration of the embodiment.

In addition, some or all of the above-described configurations, functions, processing units, and the like may be implemented by hardware, for example, by designing with an integrated circuit. A processor device in a broad sense such as a field programmable gate array (FPGA) or an application specific integrated circuit (ASIC) may be used as the hardware.

### REFERENCE SIGNS LIST

100 Nuclear reactor containment vessel
101 Inspection camera
102 Cable
103 Captured image
104 Weld bead
105 Pseudo crack image generation computer
106 Pseudo crack image
107 Crack image
108 Crack determination AI
201 Inspection image
211 Contour line
212 Determination assistance output
310 Learning target video
311 Frame selection unit
312 Edge cutting unit
313 Feature learning unit
314 Identification learning unit
315 Feature model
316 Identification model
320 Evaluation target video
321 Frame selection unit
322 Edge cutting unit
323 Feature amount conversion unit
324 Inference unit
325 Output processing unit
401, 402 Patch image
500 Calculator
501 CPU
502 ROM
503 RAM
504 Display device
505 Input device
506 Nonvolatile storage
507 Network interface
801 Pixel
802 Crack pattern
803 Crack pattern
901 Pseudo crack image
902 Input image
903 Image formation lens
904 Image sensor
905 Formed image

What is claimed is:

1. A crack image generation method of generating a crack image by a calculator (500) including a computation device (501) configured to execute a program and a storage device (502) configured to store the program, the crack image generation method comprising:
processing of generating, by the computation device (501), a pseudo crack image (106) by randomly determining a value of at least one element among elements defining a shape of a pseudo crack using a random number; and
processing of generating, by the computation device (501), a crack image (107) by superimposing the pseudo crack image (106) on an image (103) of a real subject.

2. The crack image generation method according to claim 1, wherein
the elements defining the shape of the pseudo crack include a global length of the pseudo crack, an average opening width of the pseudo crack, the number of bending segments of the pseudo crack, a global extension direction of the pseudo crack, and a position at which the pseudo crack is superimposed on the image (103) of the real subject, and
the computation device (501) randomly determines values of one or more elements among the number of bending segments of the pseudo crack and the global extension direction of the pseudo crack using a random number.

3. The crack image generation method according to claim 2, wherein
the elements defining the shape of the pseudo crack further include a boundary position between adjacent bending segments of the pseudo crack, and
the computation device (501) further randomly determines the boundary position between the adjacent bending segments using a random number.

4. The crack image generation method according to claim 3, wherein
the computation device (501) sets a shape of a bending segment on each of both end sides of the pseudo crack among the bending segments of the pseudo crack to a triangle whose vertex is at an end, and sets shapes of other bending segments to a quadrangle.

5. The crack image generation method according to claim 4, wherein
the elements defining the shape of the pseudo crack further include the number of divided segments obtained by dividing the bending segment, a displacement amount of a boundary position between the divided segments connecting division points of the bending segment, and a rotation angle of the divided segment with respect to an extension direction of the bending segment, and
the computation device (501) randomly determines values of one or more elements among the number of divided segments of the bending segment, the displacement amount of the boundary position between the divided segments, and the rotation angle of the divided segment with respect to the extension direction of the bending segment using a random number.

6. The crack image generation method according to claim 5, wherein
the computation device (501) defines values of the number of bending segments of the pseudo crack, the global extension direction of the pseudo crack, and the number of divided segments of the bending segment using uniform random numbers within a predetermined range, and varies a predetermined standard deviation with a normally distributed random number to define a deviation with respect to values of the boundary position between the bending segments, the displacement amount of the boundary position between the divided segments, and the rotation angle of the divided segment with respect to the extension direction of the bending segment.

7. The crack image generation method according to claim 1, wherein
the computation device (501) determines a luminance of a pixel of the image (103) of the real subject on which the pseudo crack image (106) is superimposed based on {Io×(Sp−So)+Ic×So}/Sp, in which So represents an area by which the pseudo crack superimposed on a quadrangle of the pixel having a side length corresponding to a relative pixel pitch in projection of the image (103) of the subject onto the real subject at a corresponding pixel position on the projection, and a quadrangle of the pixel overlap each other at each pixel position of the image (103) of the real subject on which the pseudo crack image (106) is superimposed, Sp represents an area of the pixel, Io represents a luminance of the pixel before the pseudo crack is superimposed, and Ic represents a luminance of the pixel of the pseudo crack to be superimposed.

8. The crack image generation method according to claim 1, wherein
the computation device (501) sets a projection of the image of the real subject on which the pseudo crack image (901) is superimposed onto the real subject as a virtual subject (902), and generates the crack image obtained by superimposing the pseudo crack image (901) on the image of the real subject by calculating an optical image (905) of the virtual subject formed on an image sensor (904) of a camera based on an optical theory according to optical conditions of the camera that has imaged the real subject.

9. The crack image generation method according to claim 7, wherein
the image (103) of the real subject is a color image, and the computation device (501) calculates a pixel luminance of the image (103) of the real subject after the pseudo crack image (106) is superimposed for light of each of basic colors, and determines the pixel luminance based on a calculation result for each basic color.

10. A machine learning method of a crack determination artificial intelligence (AI) executed by a calculator (500) including a computation device (501) configured to execute a program and a storage device (502) configured to store the program, the machine learning method comprising:
processing of acquiring, by the computation device (501), a data set including a crack image (107) and a ground truth label regarding a presence or absence of a crack; and
processing of inputting, by the computation device (501), the crack image (107) and the ground truth label to a training target model (316) to train the training target model (316) so as to determine the presence or absence of a crack for an inspection target image (201),
wherein the crack image (107) is an image generated through a process of generating the pseudo crack image (106) by randomly determining a value of at least one element among elements defining a shape of a pseudo crack using a random number and a process of superimposing the pseudo crack image (106) on an image (103) of a real subject.

11. A crack inspection method executed by a calculator (500) including a computation device (501) configured to execute a program and a storage device (502) configured to store the program, the crack inspection method comprising:
processing of acquiring, by the computation device (501), an inspection target image (201); and
processing of determining, by the computation device (501), a presence or absence of a crack in the inspection target image (201) using a trained model, wherein
the trained model is trained to determine the presence or absence of a crack in the inspection target image (201) using a crack image (107) obtained by superimposing a pseudo crack image (106) on an image (103) of a real subject and a ground truth label regarding the presence or absence of a crack, and
the crack image (107) is an image generated through a process of generating the pseudo crack image (106) by randomly determining a value of at least one element among elements defining a shape of a pseudo crack using a random number and a process of superimposing the pseudo crack image (106) on the image (103) of the real subject.
